(19) United States
(12) Patent Application Publication
(10) Pub. No.: US 2014/0047349 A1
(43) Pub. Date: Feb. 13, 2014

(54) Application Neutral Visual Sharing

(71) Applicant: Pro Softnet Corporation, Calabasa, CA (US)

(72) Inventors: Raghavendra Kulkarni, West Hills, CA (US); Vilabh Mishra, Glendale, CA (US); Diganta Dutta, Woodland Hills, CA (US); Gaurav Sanghavi, Calabasas, CA (US); Ajit Sirohi, Calabasas, CA (US)

(73) Assignee: PRO SOFTNET CORPORATION, Calabasas, CA (US)

(21) Appl. No.: 13/843,113

(22) Filed: Mar. 15, 2013

Related U.S. Application Data
(60) Provisional application No. 61/681,144, filed on Aug. 9, 2012.

(51) Int. Cl. G06F 3/0482

(52) U.S. Cl. CPC G06F 3/0482
USPC 715/739

(57) ABSTRACT

A comprehensive visual sharing application, method and/or technique that combines all elements of sharing in a visual and seamless manner for data that resides either on a personal computer or on remote storage servers. A user has the ability to share data where almost every activity related to sharing data is done through visual representations of data and contacts to enhance ease of sharing. The visual sharing process may occur across several different application platforms, such as web interfaces, desktop application, and social networks.

### CROSS REFERENCE TO RELATED APPLICATION

This application claims the benefit of U.S. Provisional Application No. 61/681,144, filed Aug. 9, 2012, which is incorporated herein by reference.

### BACKGROUND

A typical user of electronic devices may store data files at a variety of different places including hard drives on personal computers, transportable media such as CD's, DVDs, USB storage devices and portable hard drives, as well as on remote storage devices accessible using the Internet, often referred to as the “cloud”. When users want to share these files with others, they have customarily made copies of the files and provided them on a transportable media or shared the files electronically as an attachment to an email message.

With the expansion of cloud based services and social networks, new ways to share information have evolved (e.g. public and private online posts), although the sharing of actual data files is still done in a traditional manner. For example, sharing data that is stored in the cloud is done traditionally with email or social contact where, once the data is selected, options are provided to the user to select emails or social contacts from a list. The process may be further optimized by defaulting the contacts based on first few characters entered by the user. Even though the current process may be simple, it usually requires the user to manually enter a list of personally identifiable information (e.g. emails or social network identifications) to initiate the sharing of data with the intended recipients.

For these reasons, there exists a need for an integrated solution that allows a user to more easily share their data through a visual and frictionless means that does not require the repetitive motion of manually entering recipient information to initiate sharing of data.

### BRIEF SUMMARY

Some embodiments provide a comprehensive visual sharing application, method and/or technique that combines all elements of sharing in a visual and seamless manner for data that resides either on a personal computer or on the cloud. This technique will allow users to share data where almost every activity related to sharing data is done through visual representations of data to enhance ease of sharing. In addition, such visual sharing may occur across several different application platforms, such as web interfaces, desktop application, and social networks.

Some embodiments provide a method where a piece of data, located on either a local user computing device (operating system interface) or the cloud (via a browser platform or client application), can be shared with a contact(s) or a group(s) of contacts by a simple visual process.

The visual sharing process may include using a drag-n-drop motion where a user can select and drag a data file or representation of the data file, which may reside either on the desktop or in the cloud, onto an icon that represents a contact or a group of contacts to effectuate the sharing of the data file.

The contacts or groups of contacts may be presented in an automatically arranged fashion, where the arrangement may be based on popularity/frequency of use, online/offline status, alphabetically, or other similar parameter. The group of contact may also be represented as a deck-of-contacts which expands when a group is selected for ease of visual representation or any other smooth visual effects that allows the members of a group to be easily viewed by the user.

A share view may provide the user with a visual list of current shared data. The data may include associated contacts/groups of contacts with whom the data has been shared and a representation of the contacts may be displayed around the shared data in a visually appealing manner. This share view may also provide the user with the ability to manage the shares visually (e.g., to delete, add, or update contacts who have share access). A visual representation may also be used to indicate whether the data has been viewed by a particular contact and group.

The data files may also be displayed as thumbnail icons to provide additional visual feedback to the user. For example, a thumbnail preview image may be provided on an icon for pictures/image files, and images for data files (e.g., text documents, spreadsheets, presentations, etc.) may show a thumbnail preview of the first page (or relevant excerpt) of the data file.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGS.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the invention are set forth throughout this disclosure. However, for purpose of explanation, some embodiments of the invention are set forth in the following drawings.

FIG. 1 illustrates an exemplary graphical user interface for one embodiment of a visual sharing application according to the present invention;

FIG. 2 illustrates a manual sharing operation of user data in one embodiment of a visual sharing application;

FIG. 3 illustrates a public visual share operation in one embodiment of a visual sharing application;

FIG. 4 illustrates a public visual share screen in one embodiment of a visual sharing application;

FIG. 5a illustrates an individual visual share operation in one embodiment of a visual sharing application;

FIG. 5b illustrates an individual visual share operation in one embodiment of a visual sharing application;

FIG. 6 illustrates a visual group creation operation in one embodiment of a visual sharing application;

FIG. 7 illustrates the visual group creation operation of FIG. 6;

FIG. 8a illustrates the creation of a group using the visual group creation operation in one embodiment of a visual sharing application;

FIG. 8b illustrates the addition of a contact to the group created in FIG. 8a;

FIG. 8c illustrates the successful addition of a contact to the group created in FIG. 8a;

FIG. 8d illustrates visual sharing of local data with the group created in FIG. 8a;

FIG. 8e illustrates the simultaneous uploading and sharing of local data with the group created in FIG. 8a;

FIG. 9 illustrates a sample message sent to a contact after the execution of a share;

FIG. 10a illustrates an exemplary share management interface in one embodiment of a visual sharing application;

FIG. 10b illustrates displaying recipients of a shared data item;

FIG. 10c illustrates displaying recipients of a shared data item;

FIG. 11 illustrates a flow chart of a conceptual process used by some embodiments to define and store a visual sharing application of some embodiments; and

FIG. 12 illustrates a schematic block diagram of a conceptual computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

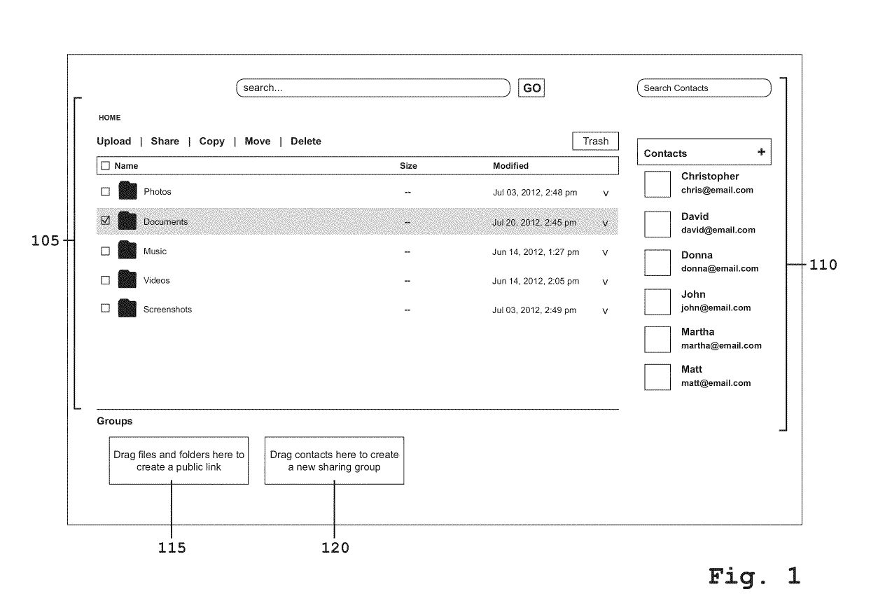

FIG. 1 illustrates an exemplary graphical user interface for one embodiment of visual sharing. As shown, the graphical user interface may include a file management area 105, a contacts list 110, a public link generator 115, and a sharing group generator 120.

The file management area 105 will display data that the user has stored remotely from his local computer, on the local computer, or a combination of both. Some embodiments may provide visual indications through badges, for example, to indicate the location of the data file (e.g., remote or local). The contacts list 110 displays a list of interactive elements representing contacts that the user can share his data with. This list can be populated by manual entry of contacts, by importing existing contacts from an address book, or through a third party application extension. Such third party applications may include social network integration tools (e.g., application program interfaces, “APIs”) which may allow contacts from a user's social network to appear in the contact list 110 after validation of the user's credentials for that particular social network. The public link generator 115 may allow a user to quickly create a public link (e.g., a uniform resource identifier or uniform resource locator) to his data through visual sharing (e.g., drag and drop actions), and the sharing group generator 120 allows a user to visually create groups of contacts to share data with.

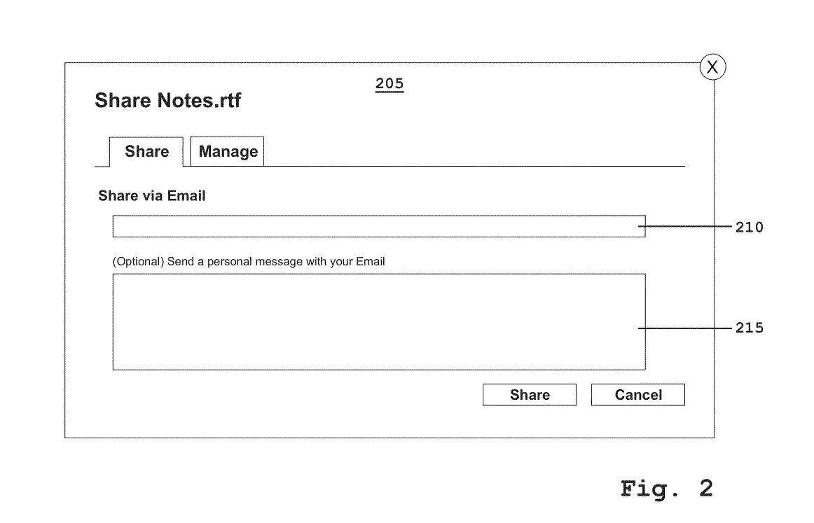

FIG. 2 illustrates a manual sharing operation of user data. This manual sharing operation is how data is typically shared. For example, after a user selects one or more data files or folders and executes a share command, the user may be presented with a share screen 205. From here, the user can manually enter email addresses or social network contacts that the user would like to share his data with. When populating the contacts field 210 with intended share recipients, the user may be provided with a subset of contact after entry of a few characters, wherein the subset of contacts coincide with the characters entered in order to present the user with the closest matching contacts from his contacts or social network list. The user may also be presented with a text box 215 for adding a personal message regarding the share. This manual process may be tedious and time consuming, thus a visual sharing operation as discussed may alleviate excessive user operation typically required to effectuate the sharing of data.

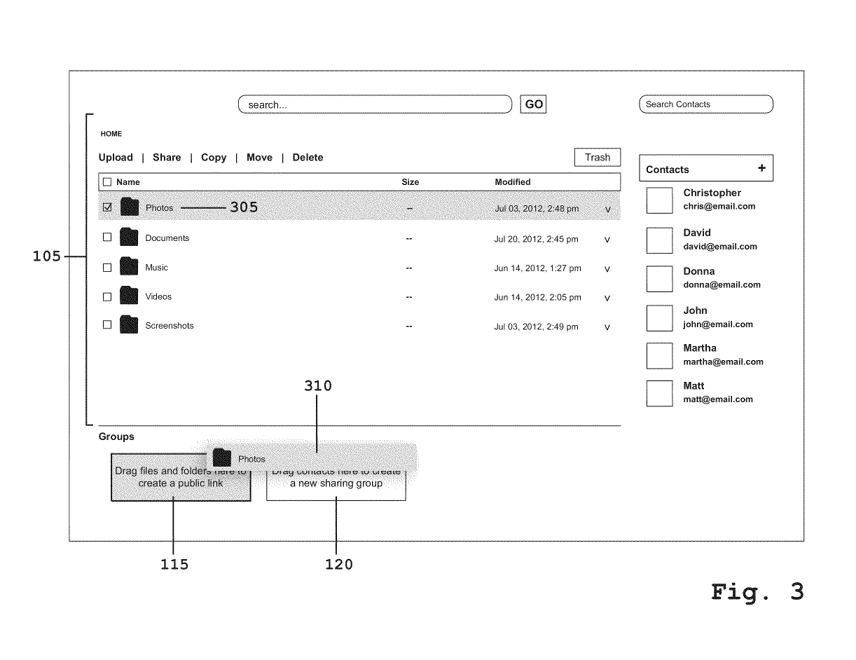

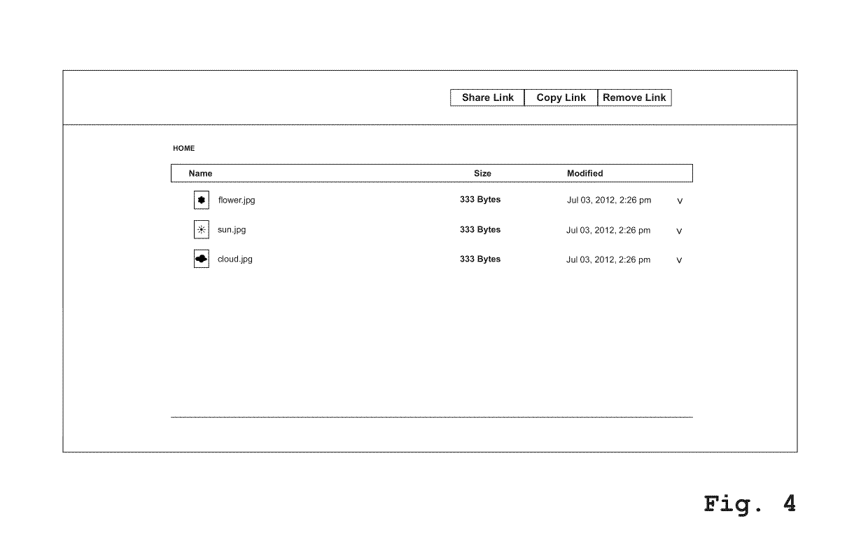

FIG. 3 illustrates a public visual share operation of some embodiments. As illustrated, a user can select a data item from the file management area 105 and, while holding the data item selection, drag that data item to a location on the screen where an operation on that data item can be executed. Here, the data item is the ‘Photos’ folder 305. As shown, the user can drag a representation of the Photos folder 310 to the public link generator 115. Once the representation of the Photo folder 310 is dropped on top of the public link generator 115, some embodiments may present the user with a public link visual share screen of FIG. 4.

As illustrated in FIG. 4, the public link visual share screen may present the user with a screen populated by the data items belonging to a particular public share operation. Some embodiments may provide the user with options to share the link (e.g., through a contact entry process), to copy the link, or to remove the link so that it is no longer accessible.

The public link that is generated may direct recipients in possession of the link to a similar screen via a web browser, for example, and present the recipient with each data item that was shared. Each item may be downloadable by the recipient individually, through a selection of multiple items, or all items at one time. When a recipient chooses to download multiple items at once, he may be provided with a compressed file containing all the selected data items in some embodiments.

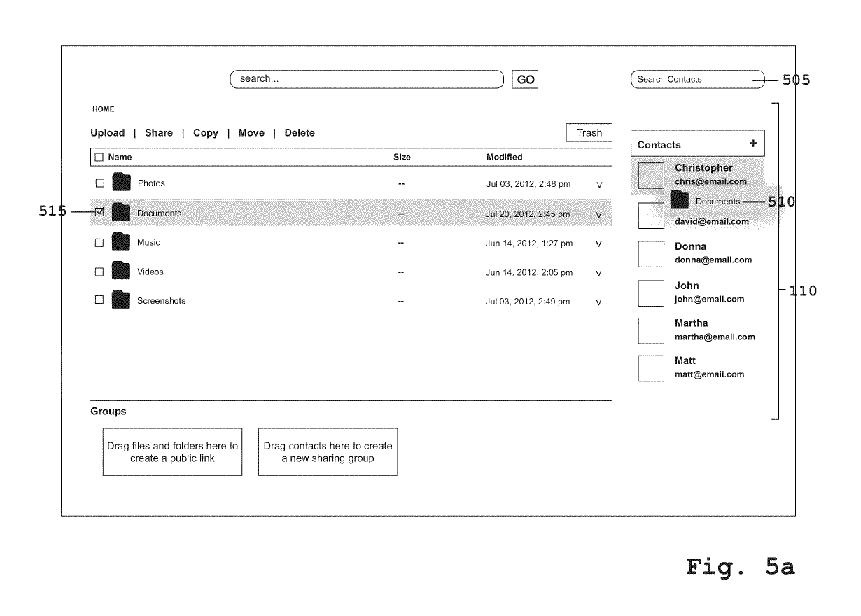

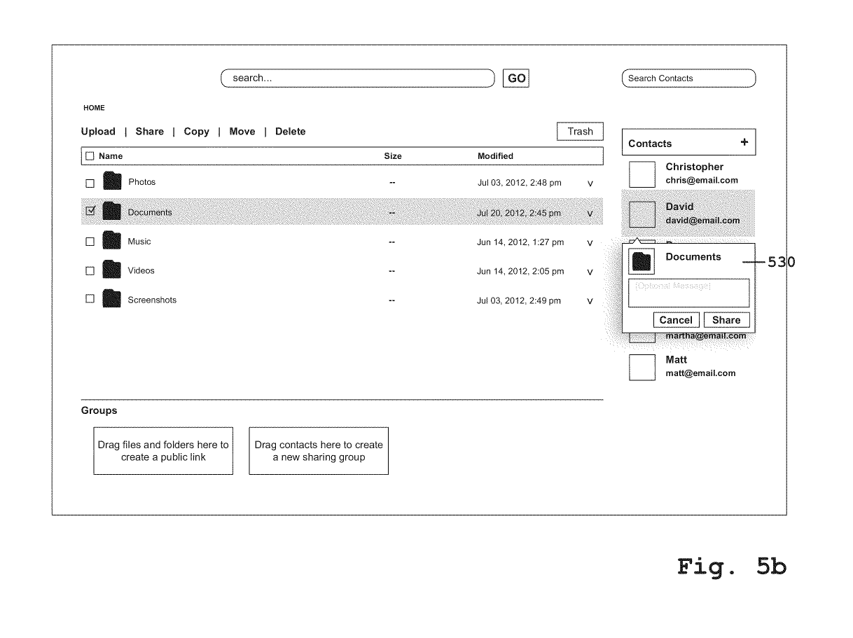

FIG. 5a illustrates an individual visual share operation of some embodiments. Here, as explained above for FIG. 3, a user can select a data item or folder 515 and drag a representation of the data item 510 over to any single individual contact in the contact list 110. If a user has several contacts populated in the contacts list, the user may first choose to filter the contacts using a contacts search box 505. Once the representation of the data item 510 is dropped on top of a particular contact, the process for effectuating the share occurs in the background and no further action by the user may be required. A share generation module may operate in the background that, for example, will create a share link and email the link to the recipient, send it as a private message through a social network, or post the link to a social network board where the link may only be accessible by the intended recipient via the social network. As illustrated in FIG. 5b, some embodiments of the visual sharing application may present the user with a pop up box 530 that displays the name of the file or folder that was dropped on the contact along with a text entry area for the user to enter a personal message to be delivered along with the message that will be sent to the recipient notifying the recipient of the shared data item.

During the drag and drop process, the user may receive visual feedback so he is aware that he is dragging a data item and when that data item can be dropped on top of a particular operation. For example, if the user hovers a data item representation above a contact, the data item representation and/or the contact may become highlighted or blink to indicate the user can drop the data item to execute the share.

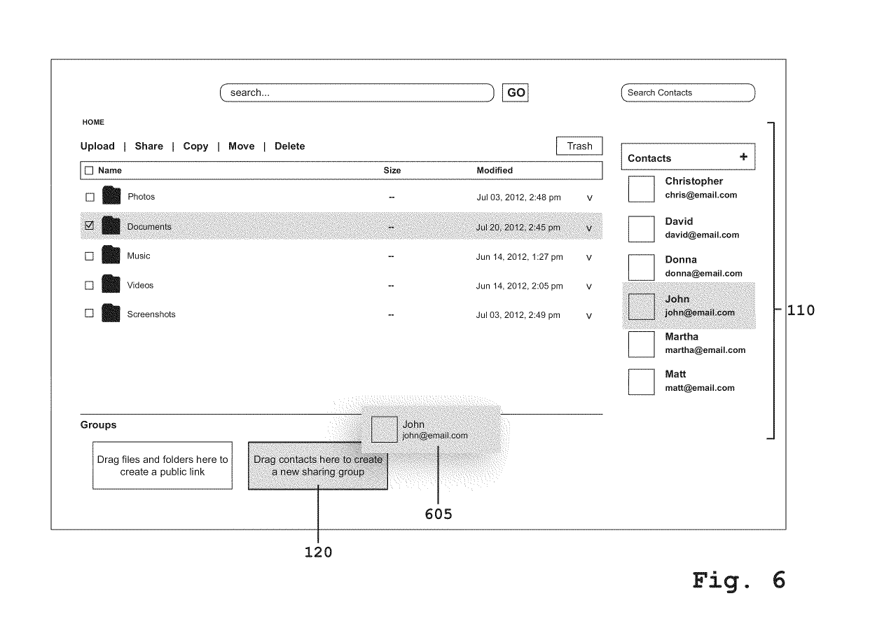

If the user wants to share a data item or folder with multiple recipients in a similar seamless and visual manner, the user may do so using a visual group share. To share data with a group of contacts the user will first need to create a sharing group as illustrated in FIG. 6. To visually create a sharing group, a user selects a contact from the contact list 110 and then drag and drops a representation of the contact 605 into the sharing group generator 120 to create a new group.

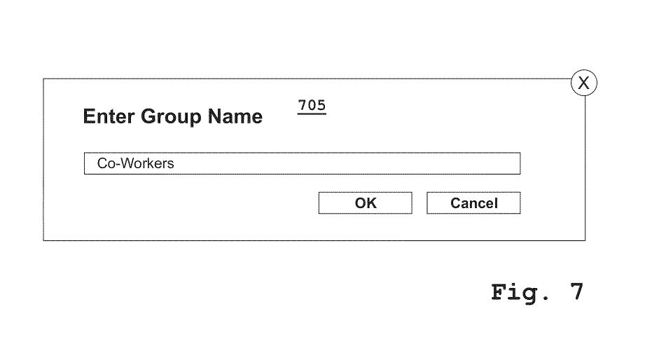

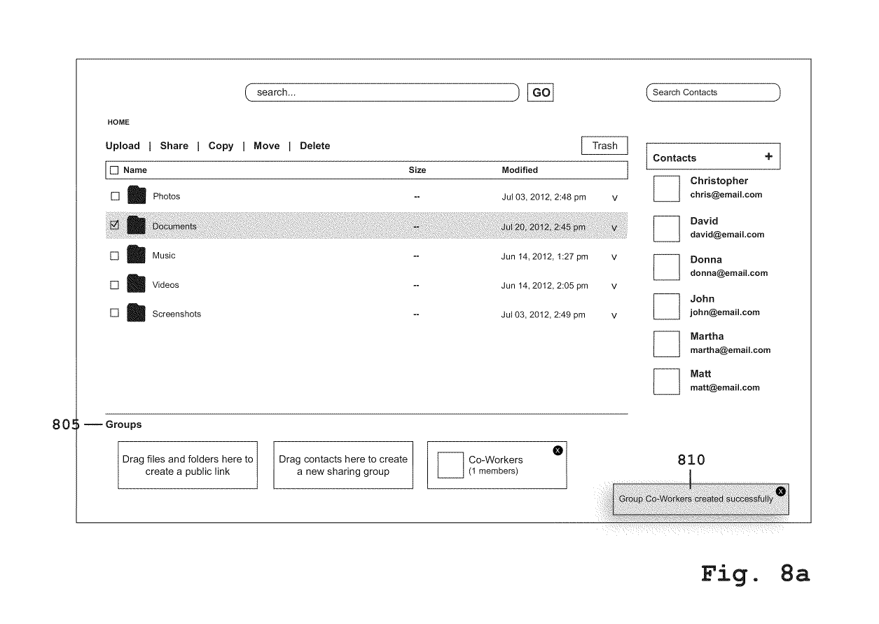

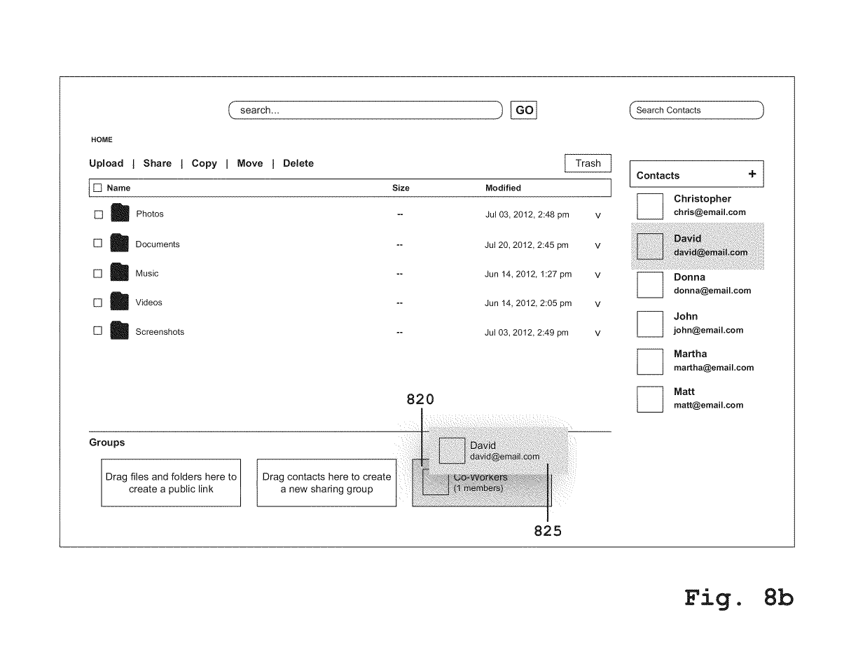

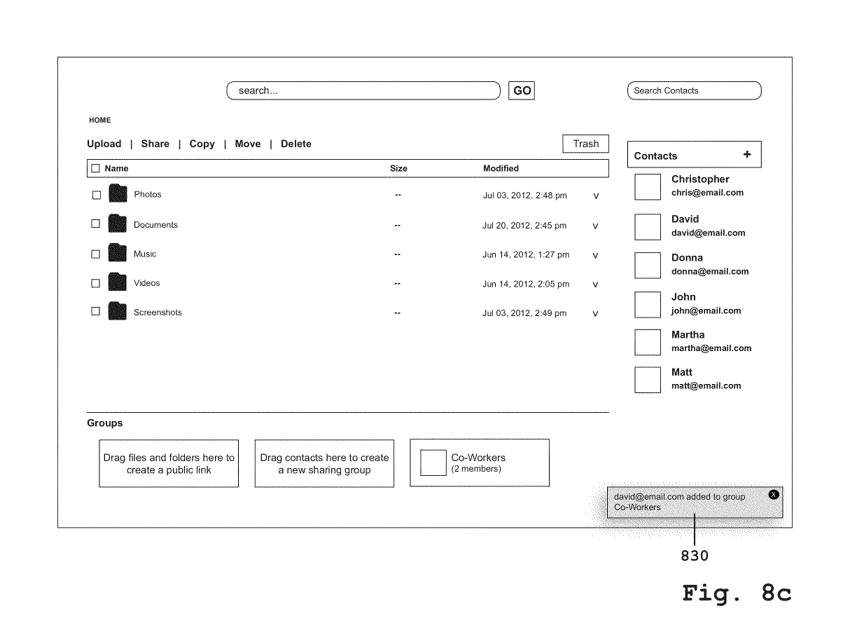

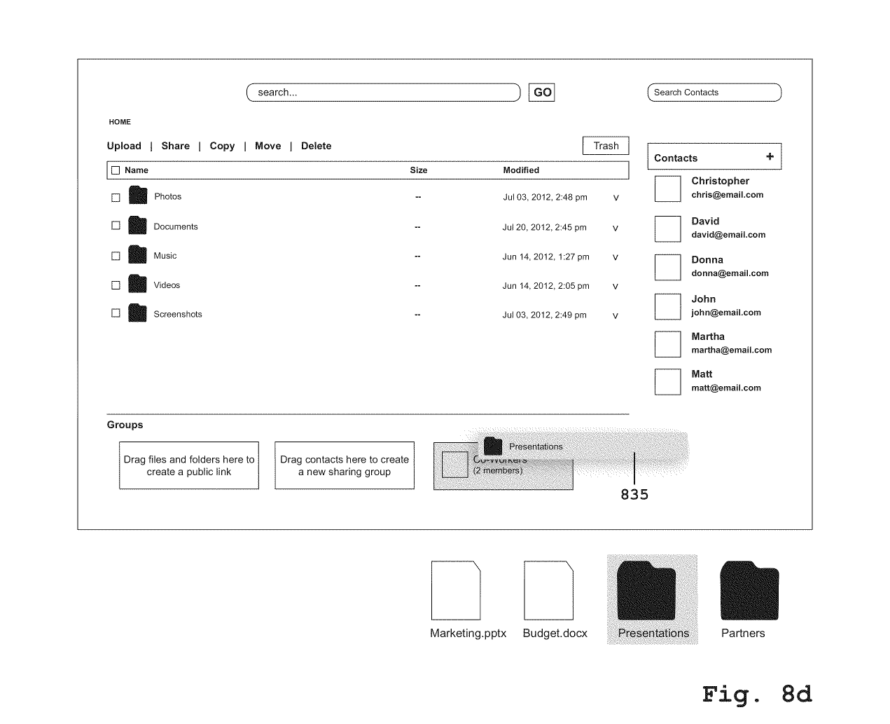

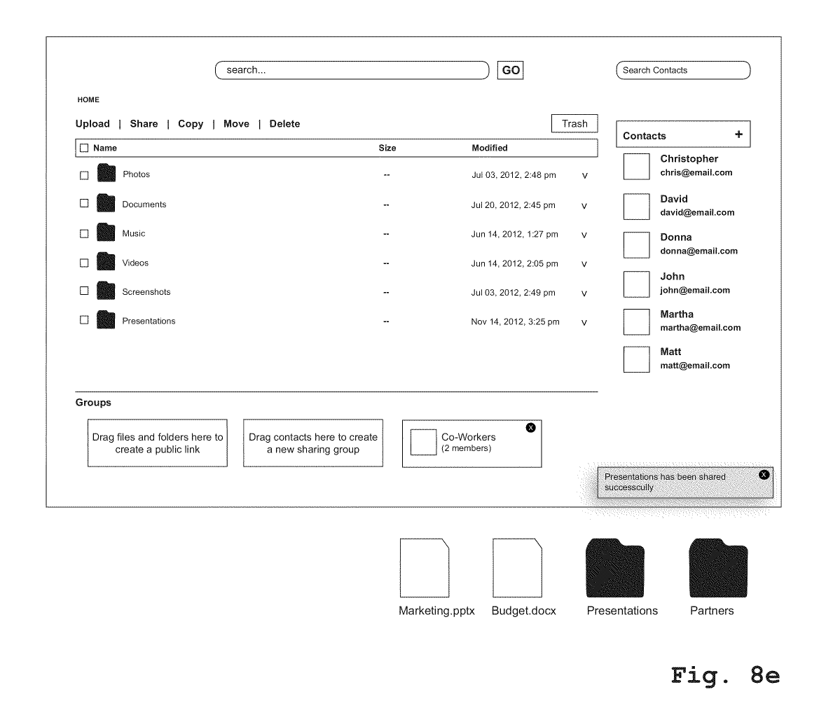

As illustrated in FIG. 7, when a contact is dropped in the sharing group generator 120, the user may be presented with a notification 705 requesting a group name. As illustrated in FIG. 8a, a successfully created group may be shown as a graphical representation. Some embodiments may present the group representation in a “Groups” section 805 of the graphical user interface. Some embodiments may also provide the user with visual feedback using notifications 810 that may indicate, for example, a successful creation of a group and/or successful addition of a contact to a particular group. As illustrated in FIG. 8b, if a user wants to add a contact to an existing group, the user would drag and drop a representation of a contact 820 into an existing group 825. As illustrated in FIG. 8c, the user may be presented with a notification 830 confirming the addition of a contact to a particular group. Each group may be created using manually entered contact, imported contacts, social network contacts, or any combination allowing the user to create mixed contact groups across different operating platforms and/or social networks.

Groups may also be represented in a graphically pleasing manner to the user. For example, a group may be presented as a deck of cards where, upon clicking or scrolling over the group, the deck would be fanned out so the user can easily view the current active members he has assigned to the particular group. Some embodiments may use other visual effects such as a circular expansion of the contacts, or mini representations where a current/highlighted contact appears larger than the rest for easy viewing. The visual expansion of the group of contacts may also be dynamic in that a larger number of contacts in a group will expand more widely than a group with a smaller number of contacts.

Furthermore, to make the visual sharing process even more seamless, a user may also drag and drop data items directly from his local machine (e.g., a file or folder from his desktop or stored on his local computer) directly into the visual sharing program which may reside as a client application on the local computer or as a web based application accessible through a web browser.

Some embodiments of visual sharing may be accomplished using a web based application. For example, an exemplary embodiment may use Javascript on the front end to detect and effectuate a visual share operation. The web application allows data items (files, folders, contacts, etc.) to be represented as HTML elements. The HTML element may also be presented to the user as a thumbnail representation of the data item. For example, an image file may be represented as an HTML element that is a thumbnail of the image or a data file may be represented as an HTML element that is a thumbnail image of the first page or any relevant page of the data file.

Web browsers allow a user to drag HTML elements representing a data item on to other HTML elements (e.g., email contacts, social network contacts, or a group). When the HTML element representing the data item is dropped on to the HTML element representing a contact or group, the drop event is detected by the visual sharing web application. The drop event may be detected using Javascript for example, which subsequently may send an AJAX request to a remote server for processing of the drop event and the ultimate creation of a share. The remote server may be a share management server that may operate independently from a remote storage server for storing share data in some embodiments, while other embodiments may use a single server to store shared data and manage a database of sharing activity.

Another exemplary embodiment to effectuate visual sharing functionality may be accomplished using an application residing locally on a user's computer. A similar process as described above may be used to effectuate a visual share using a local application through use of drag and drop functionality widely available on local operating systems. For example, icons representing data files may be selected and dragged to different areas of a computer screen. The operating system will recognize the open visual sharing application and communicate with the visual sharing application regarding drag and drop events. When the visual sharing application detects a drop event, the application may ascertain where in the application window the drop event occurred (e.g., on a contact or group contact) and send a message or command to a remote server that will effectuate the sharing of the file or folder with the contact(s) identified via the drop event.

In some embodiments, if a user chooses to drag a data item directly from his local machine onto any area within the visual sharing application, the data item may be uploaded to a remote storage area of the service provider of the sharing application. A default remote storage area (e.g., to a home directory) may be used to store the dropped file if the user does not choose a specific location to store the data file. If the user drags the data item onto a particular folder, then the data item may be uploaded to that particular folder. As illustrated in FIG. 8d, a representation of a data item 835 may also be dropped on top of a contact or group from a user's local machine. Some embodiments may prompt the user to confirm a dropped share operation while options may also be provided to create the share without any further interaction. As shown in FIG. 8e, the data item 840 may be uploaded to a default or designated location on the remote storage and the share may be effectuated 845 all in one seamless motion from the user's perspective. The operation of uploading the data to remote storage of the service provider allows the intended recipients to have anytime access to the data items via the provided link. Some embodiments may provide links that allow for direct download of the data item, while other embodiments may send the recipient to a web page where he can view the contents of the data item and/or download the data item(s) to his local computer. Some embodiments may also allow recipients to edit and/or upload a new version of the same data item for access by all authorized users. Such embodiments may also create versions of each modified data item and track which contact saved each new version of the data item.

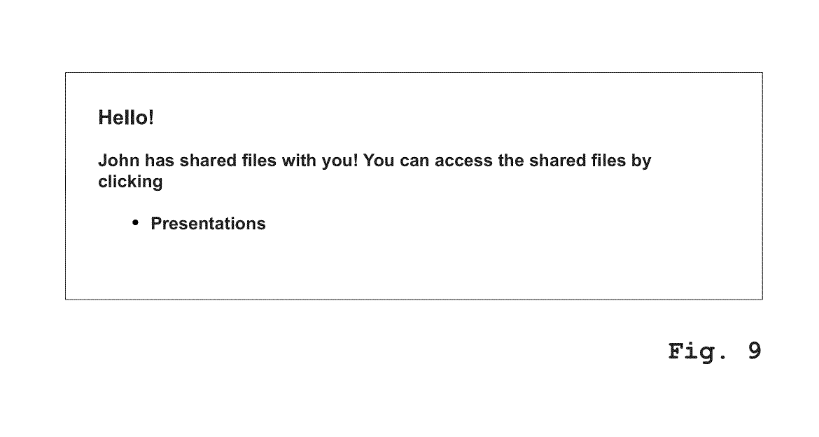

In some embodiments, once a request to create a share is received by the remote server, a unique identification representing the share may be generated and stored in a database. Then the contact or group of contacts with which the data item is shared is also recorded with the share identification to identify which users have access to the data item. A URL link or similar address representing the share may then be sent to the contact via email, text, third party applications, or via a social network as applicable. FIG. 9 illustrates a sample message that may be sent to a contact after the execution of a share.

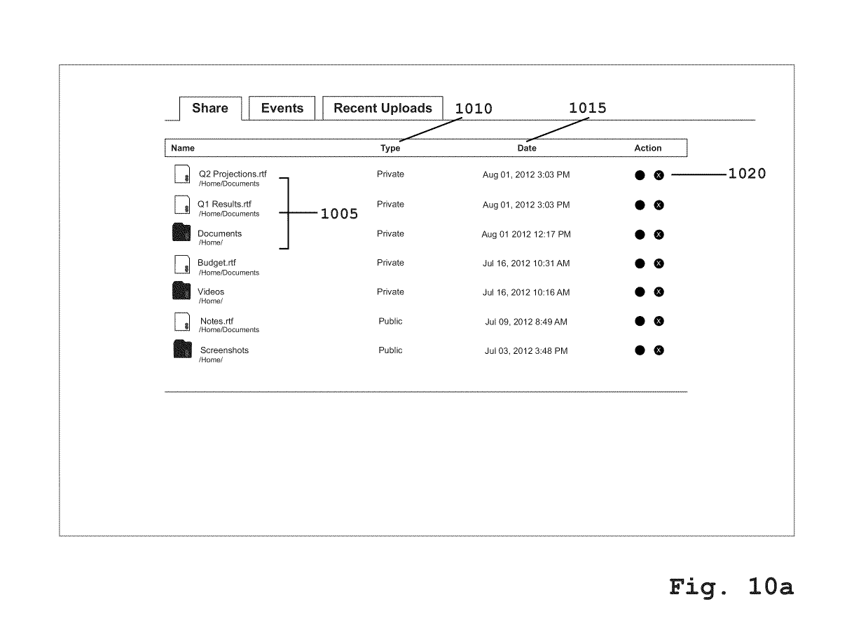

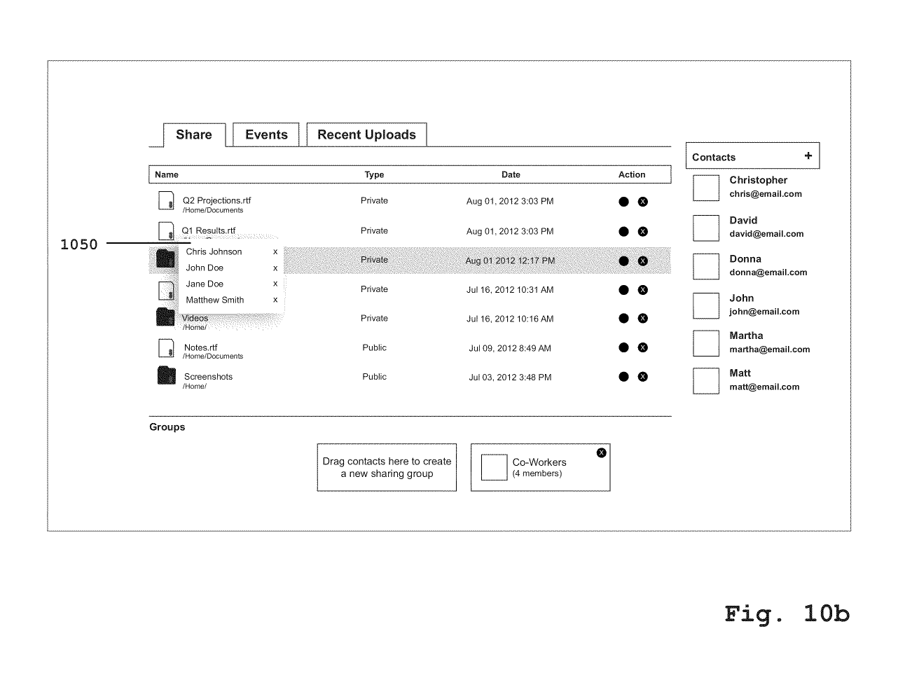

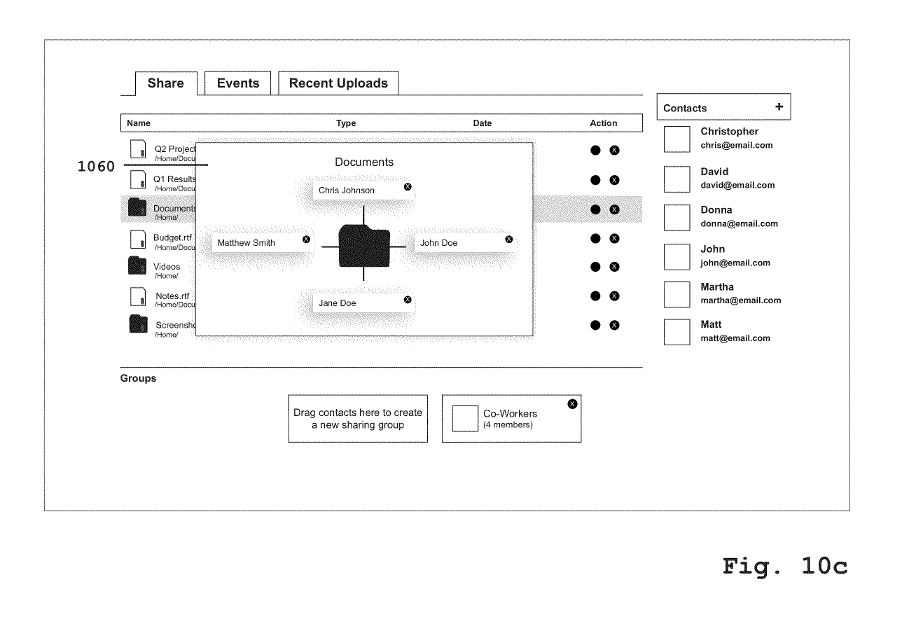

Some embodiments of the sharing application may provide the user with a share management interface from where the user can visually manage his shared items and the contacts that have access to particular shared data items. FIG. 10a illustrates an exemplary embodiment of a share management interface. As shown, the name of a shared data item 1005 may be shown, along with the type of share 1010 (e.g., public or private), the date 1015 the share was executed, and icons 1020 which may allow the user to perform management function of the share (e.g., delete or modify the share). For example, some embodiments may allow a user to modify a share where clicking on the shared data item causes the contact recipients of the share to be displayed in a list 1050 near the shared data item as shown in FIG. 10b. As illustrated in FIG. 10c, some embodiments may display a graphical expansion 1060 of the share recipient contacts in a circular or “ring” formation around the data item or in other similar graphical expansions to indicate which contacts have access to the data item. From the share management interface, a user may be able to delete recipients to deny further share access to the data file. Some embodiments may allow a user may to drag new contacts into the “ring” of recipients or remove a contact from the “ring” of recipients by simple drag drop operations or quick movements of contacts into and out of the “ring”.

### Process for Defining a Visual Sharing Application

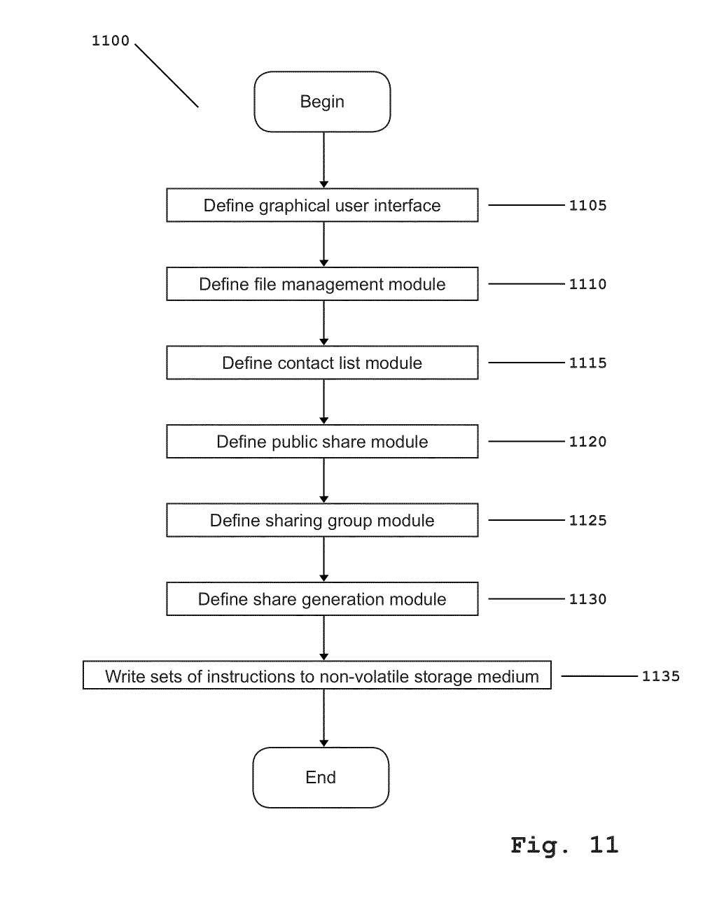

FIG. 11 illustrates a flow chart of a conceptual process 1100 used by some embodiments to define and store a visual sharing application of some embodiments. Specifically, process 1100 illustrates the operations used to define sets of instructions for providing several of the elements described above and for performing fie management, contact management, group creations, sharing functionalities, etc. The process 1100 may be used to generate a visual sharing application of some embodiments.

Process 1100 may begin when a manufacturing facility generates a computer program product for use by consumers. As shown, the process may define (at 1105) sets of instructions for implementing a graphical user interface (e.g., as described above in reference to FIG. 1). In some cases such sets of instructions are defined in terms of object-oriented programming code. For example, some embodiments may include sets of instructions for defining classes and instantiating various objects at runtime based on the defined classes. The process then defines (at 1110) sets of instructions for implementing a file management module.

Next, process 1100 defines (at 1115) sets of instructions for implementing contact list module (e.g., adding contacts, importing contacts, social network integration, and displaying of contacts). Process 1100 then defines (at 1120) sets of instructions for implementing a public share module (e.g., public share generator 115 described above in reference to FIG. 3). Then process 1100 defines (at 1125) sets of instructions for implementing a sharing group module (e.g., to create sharing groups as described above in reference to FIG. 6-FIG. 8c). The process 1100 may then define (at 1130) sets of instructions for implementing a share generation module (e.g., to effectuate a visual share with a contact or group of contact). Finally, the process writes (at 1135) the sets of instructions to a non-volatile storage medium.

One of ordinary skill in the art will recognize that the various sets of instructions defined by process 1100 are not exhaustive of the sets of instructions that could be defined and stored on a computer readable storage medium for a visual sharing application incorporating some embodiments of the invention. In addition, the process 1100 is a conceptual process, and the actual implementations may vary. For example, different embodiments may define the various sets of instructions in a different order, may define several sets of instructions in one operation, may decompose the definition of a single set of instructions into multiple operations, etc. In addition, the process 1100 may be implemented as several sub-processes or combined with other operations within a macro-process.

### Computer System

Many of the processes and modules described above may be implemented as software processes that are specified as at least one set of instructions recorded on a non-transitory storage medium. When these instructions are executed by one or more computational elements (e.g., microprocessors, microcontrollers, Digital Signal Processors (“DSPs”), Application-Specific ICs (“ASICs”), Field Programmable Gate Arrays (“FPGAs”), etc.) the instructions cause the computational element(s) to perform actions specified in the instructions.

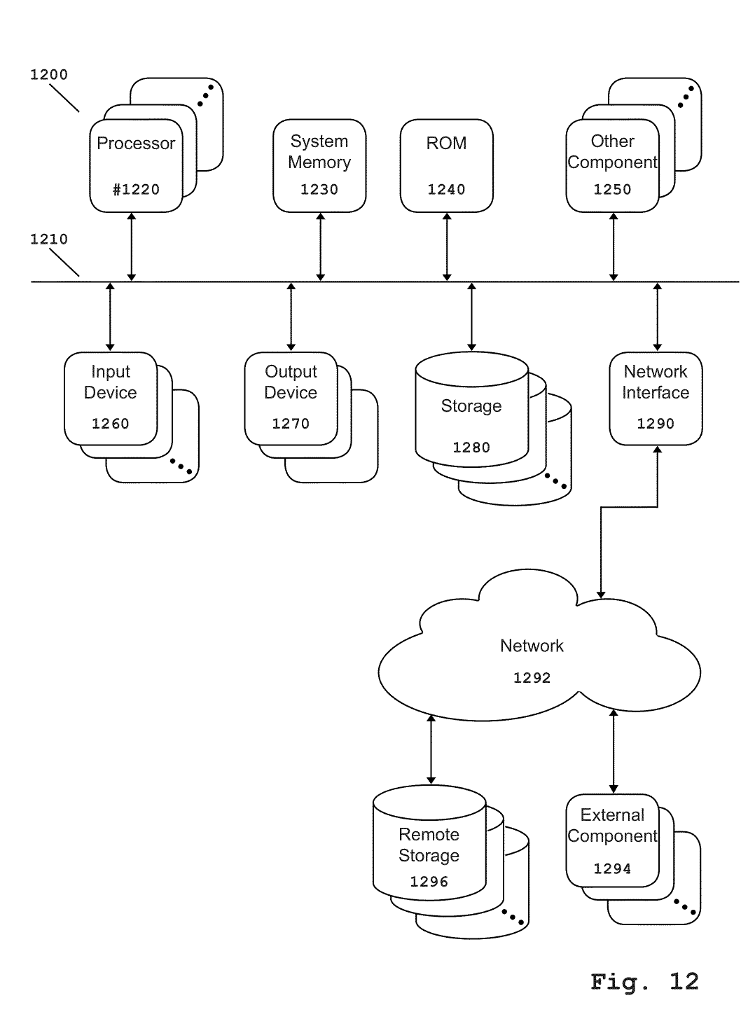

FIG. 12 illustrates a schematic block diagram of a conceptual computer system 1200 with which some embodiments of the invention may be implemented. For example, the visual sharing application described above may be at least partially implemented using computer system 1200. As another example, the processes described to effectuate a visual share operation may be at least partially implemented using sets of instructions that are executed using computer system 1200.

Computer system 1200 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 1200 may include a bus 1210, at least one processing element 1220, a system memory 1230, a read-only memory (“ROM”) 1240, other components (e.g., a graphics processing unit) 1250, input devices 1260, output devices 1270, permanent storage devices 1280, and/or a network connection 1290. The components of computer system 1200 may be electronic devices that automatically perform operations based on digital and/or analog input signals.

Bus 1210 represents all communication pathways among the elements of computer system 1200. Such pathways may include wired, wireless, optical, and/or other appropriate communication pathways. For example, input devices 1260 and/or output devices 1270 may be coupled to the system 1200 using a wireless connection protocol or system. The processor 1220 may, in order to execute the processes of some embodiments, retrieve instructions to execute and data to process from components such as system memory 1230, ROM 1240, and permanent storage device 1280. Such instructions and data may be passed over bus 1210.

ROM 1240 may store static data and instructions that may be used by processor 1220 and/or other elements of the computer system. Permanent storage device 1280 may be a read-and-write memory device. This device may be a non-volatile memory unit that stores instructions and data even when computer system 1200 is off or unpowered. Permanent storage device 110 may include a mass-storage device (such as a magnetic or optical disk and its corresponding disk drive).

Computer system 1200 may use a removable storage device and/or a destination storage device as the permanent storage device. System memory 1230 may be a volatile read-and-write memory, such as a random access memory (“RAM”). The system memory may store some of the instructions and data that the processor uses at runtime. The sets of instructions and/or data used to implement some embodiments may be stored in the system memory 1230, the permanent storage device 1280, and/or the read-only memory 1240. For example, the various memory units may include instructions for authenticating a client-side application at the server-side application in accordance with some embodiments. Other components 1250 may perform various other functions. These functions may include interfacing with various communication devices, systems, and/or protocols.

Input devices 1270 may enable a user to communicate information to the computer system and/or manipulate various operations of the system. The input devices may include keyboards, cursor control devices, audio input devices and/or video input devices. Output devices 1280 may include printers, displays, and/or audio devices. Some or all of the input and/or output devices may be wirelessly or optically connected to the computer system.

Finally, as shown in FIG. 12, computer system 1200 may be coupled to a network 1292 through a network adapter 1290. For example, computer system 1200 may be coupled to a web server on the Internet such that a web browser executing on computer system 1200 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1200 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

What is claimed is:

1. A method for visually sharing data with one or more contacts, the method comprising:
providing a visual sharing application stored on a non-transitory computer readable medium for execution by at least one processor;
configuring the visual sharing application to display one or more contacts as interactive elements;
configuring the visual sharing application to detect a drop event, wherein the drop event is detected when a representation of a data item is dragged into and subsequently dropped within the visual sharing application;
configuring the visual sharing application to detect whether the drop event occurs in connection with a contact;
creating a uniform resource identifier for navigating the contact user to an Internet web page for displaying the data item and making the data item available for download;
sending, when a drop event is detected in connection with the contact, an electronic message to the contact containing the universal resource identifier for providing the contact access to the data item;
providing a share management graphical user interface comprising a list of all shared data items; and
configuring each shared data item to display a window comprising a recipient list, wherein the each shared data item's recipient list identifies all contacts that have been granted access to a respective shared data item, wherein a user can remove and add share recipients to the shared data item by graphically maneuvering contacts into and out of the recipient list.

2. The method of claim 1 further comprising configuring the visual sharing application to allow the creation of a group contact that associates a plurality of contacts with a single interactive element by drag and drop interactions into a sharing group generator.

3. The method of claim 2 further comprising:
detecting that the drop event occurred in connection with a group contact; and
providing each contact associated with the group contact access to the data item.

4. The method of claim 1, wherein creating a universal resource identifier comprises:
creating a unique Internet link; and
associating the data item to the unique Internet link in a share table of the visual sharing application.

5. The method of claim 1, wherein the one or more contacts are contacts from a third party social network.

6. The method of claim 1, wherein the one or more contacts have associated e-mail addresses.

7. The method of claim 1 further comprising:
configuring the visual sharing application to upload the data item to a remote server when the data item resides on a user's local computer.

8. A physical computer readable medium storing a data management application for execution by at least one processor, the data management application comprising sets of instructions for:
displaying one or more contacts lists, wherein the contacts lists are populated with a plurality contacts;
displaying remote data items, wherein the remote data items are located on one or more remote storage servers;
detecting a drop event, wherein a drop event occurs when a data item is selected, dragged, and dropped on top of a contact;
sending an electronic message to the contact, wherein the message comprises the identification of the data item and a single universal resource identifier for providing online access to the data item;
displaying a share management graphical user interface (GUI), wherein the share management GUI comprises a list of all shared data items;
detecting the selection of a shared data item in the share management graphical user interface; and
displaying a share list associated with the shared data item, wherein the share list comprises all contacts that have authority to access the shared data item, wherein contacts can be (i) added to the share list by dragging a representation of another contact into the share list and (ii) removed from the share list share list by dragging a contact displayed in the share list outside the share list.

9. The physical computer readable medium of claim 8 further comprising sets of instructions for:
detecting a drop event of a local data item that is stored on the local machine of a user of the data management application; and
uploading the local data item to the remote storage server.

10. The physical computer readable medium of claim 8 further comprising sets of instructions for importing a set of contacts into the contacts list from an address book.

11. The physical computer readable medium of claim 8 further comprising sets of instructions for importing a set of contacts into the contacts list from a third party social network.

12. The physical computer readable medium of claim 11 further comprising sets of instructions for integrating social network messaging functionality to allow drop events to be communicated via a messaging system of the third party social network.

13. The physical computer readable medium of claim 8 further comprising sets of instructions for creating groups, wherein each group is populated with a plurality of contacts from the contacts list.

14. The physical computer readable medium of claim 8 further comprising sets of instructions for visually indicating when a successful sharing of the data item has been effectuated.

15. A non-transitory computer readable storage medium storing a computer program comprising a graphical user interface (GUI), the GUI comprising:
a contacts list populated with a plurality of contacts each having a contact identifier, wherein the types of contact identifiers comprise (i) an e-mail address, (ii) a social network profile, and (iii) telephone number;
a plurality of group icons, wherein each group icon is associated with a combination of contacts across one or more different mediums comprising e-mail addresses, social network profiles, and telephone numbers; and
a share management interface comprising a list of shared data items, each shared data item having an associated and unique uniform resource locator;
wherein the selection of a shared data item provides a share list window comprising a set of contacts that are authorized to view and download the shared data item, each contact in the set of contacts being represented by a interactive graphical icon that can be removed from the list by selection of the interactive graphical icon and subsequently dragging the interactive graphical icon out of the share list window.

16. The non-transitory computer readable storage medium of claim 15, wherein removing an interactive graphical icon from the share list windows terminates access to the shared data item for the contact associated with the interactive graphical icon.

17. The non-transitory computer readable storage medium of claim 15, wherein each interactive graphical icon comprises a delete button for deleting the contact associated with the interactive graphical icon from the set of contacts authorized to view and download the shared data item.

18. The non-transitory computer readable storage medium of claim 15, wherein contacts from the contact list and group icons can be selected and subsequently dragged into the share list window for providing additional contacts access to the shared data item.

19. The non-transitory computer readable storage medium of claim 15, wherein the shared data item resides on a remote storage server.

20. The non-transitory computer readable storage medium of claim 15, wherein contacts in the share list window are authorized to edit the shared data item, wherein edited data items are stored as a subsequent version of the data item.
